(19) United States
(12) Patent Application Publication
(10) Pub. No.: US 2023/0048269 A1
(43) Pub. Date: Feb. 16, 2023

(54) Apex Roller

(71) Applicant: Benjamin Philip Dawson, Lenoir City, TN (US)

(72) Inventor: Benjamin Philip Dawson, Lenoir City, TN (US)

(21) Appl. No.: 17/887,807

(22) Filed: Aug. 15, 2022

Related U.S. Application Data
(60) Provisional application No. 63/233,550, filed on Aug. 16, 2021.

(51) Int. Cl. B05C 17/02

(52) U.S. Cl. CPC B05C 17/0207

(57) ABSTRACT

A roller for applying paint or other liquid or semi-liquid substances to surfaces. The roller includes a tubular frame that extends in a cylindrical shape. This tubular frame has two ends: a first end tapers outward (away from the main body of the tubular frame) to an enclosed conical point or apex. A second end is open and adapted to permit access to the interior volume of the tubular frame by a shaft of a roller frame. The open second end of the tubular frame permits selective removal and insertion of the paint roller shaft into the tubular frame. Typically, the tubular frame is held in place on the shaft by friction. A cover wrap dimensioned to circumferentially envelop the tubular frame is also included in the assembly; this cover wrap has a liquid-absorbent outer surface adapted for temporarily retaining paint, stain, or other liquid or semi-liquid substances.

### CROSS-REFERENCE TO RELATED APPLICATIONS

This Application claims the benefit of U.S. Provisional Patent Application Ser. No. 63/233,550, filed Aug. 16, 2021, the entire content of which is incorporated herein by reference.

### STATEMENT REGARDING FEDERALLY SPONSORED RESEARCH OR DEVELOPMENT

Not Applicable

### BACKGROUND OF THE INVENTION

### 1. Field of Invention

The present invention pertains generally to paint rollers and, more particularly, to a paint roller adapted to applying paint to inner corners and edges while still being capable of applying paint to large area surfaces.

### 2. Description of the Related Art

Conventional paint rollers are generally not used in tight areas or close to edges and inner corners, owing to structural limitations of the conventional rollers that preclude their use in tight areas. Thus, a brush or other small tool is necessary to apply paint to those tight areas (i.e., to do the “edging” work) in order to complete a painting job. The resultant painted surface often shows a different texture in those places where a different painting implement has been used. The process of applying paint in tight areas is often very time consuming. Moreover, the need to use a brush or other small tool for applying paint in tight areas, in addition to use of a conventional roller for large areas, means that more painting tools must be cleaned.

A number of painting tools have been proposed for applying paint to inner corners, edges, and other tight areas. For example, U.S. Pat. No. 2,994,899, issued to Moilanen, teaches a painting roller for applying paint in the corners at the juncture of two walls, comprising a handle, a shank fixed to the handle and having a laterally extending axle, and a pair of retaining cups rotatable on said axle. Each retaining cup has an extruded portion extending inwardly in the center of the cups to facilitate the cups rotating upon the axle. The cups are each further provided with an outwardly extending circumferential flange. A bi-conical bi-frustro roller member, having the equal combined angles of the frustrums forming a right-angled exterior surface at their common bases, is provided with extrusions, extending inwardly in both of the outwardly truncated portions of the cones. A pair of applicator shells have a conical frustro shape with a 45 degree cone base angle to conform to the roller member, one shell on one side, and the other shell on the opposite side thereof. The applicator shells have an inner rigid core, of suitable material, and an outer paint absorbent covering, such as sponge rubber or the like suitably glued or otherwise affixed to the rigid core. The device taught by Moilanen, though perhaps suitable for applying paint to inner corners, is not useful for painting large surface areas away from edges and corners.

U.S. Pat. No. 3,159,905, issued to Baggett, discloses a paint roller that generally comprises a rotatable member or head and a handle. The handle has a main shank portion and an end journal portion at right angles thereto. Discs are rotatably mounted in axially spaced relation on the end portion of the handle, and the rotatable member is secured to the disc peripheries to be rotatable therewith with respect to the handle. The rotatable member comprises a core which includes the cylindrical sleeve and the frustoconical sections which are concentric with and surround the sleeve. The sleeve is preferably formed of cardboard or like sheet material which is inexpensive and of a flexible and yieldable nature. First and second frusto-conical core sections encircle said sleeve in concentric relation therewith, said sleeve and said sections being separately formed elements permanently secured together, said sections each being formed of a light gauge sheet material shaped as an annulus to provide the frustoconical form aforesaid, the small end of the first section being joined to one end of said sleeve and the small end of the second section being of the same diameter as that of the first section and joined to the opposite end of said sleeve, the large ends of said sections being of the same diameter and joined to one another intermediate the ends of said sleeve, said sections defining a substantial angle therebetween, a substantially annular, transversely split resilient element compressed within the space between said core sections and sleeve in concentric relation therewith and in bearing engagement with said sections at the junction between the large ends thereof to impose a radially outward pressure thereon. The juncture between the large ends of said core sections is disposed in a plane normal to the axis of rotation of said rotatable member nearer to the said one end of said sleeve than to the other, said first section forms an angle of approximately 30 degrees with said normal plane and said second section forms an angle of approximately 45 degrees with said normal plane. As with Moilanen, the device taught by Baggett, though perhaps suitable for applying paint to inner corners, is not useful for painting large surface areas away from edges and corners.

U.S. Pat. No. 5,412,832, issued to Irven, discloses a paint roller capable of applying paint to inner corners, edges, and along or adjacent straight lines while still being appropriate for large area surface painting. The roller has an angled end face which spaces the end away from adjacent surfaces, while the contact surface of the roller applying paint can reach up to the inner corner. The construction includes an axle having a straight portion and an angled portion attached to one end by a fixed offset link. The straight portion carries a cylindrical roller body, while the angled portion carries a frusto-conical roller body of a size to extend the substantially linear contact surface of the cylindrical roller. The cylindrical roller has an open end partially containing the frusto-conical roller. Both roller bodies are encased by a tubular covering having pile fibres for carrying paint. The covering is elastic at least in the direction parallel to the straight portion of the axle. Therefore, as the gusto-conical roller rotates it will displace the tubular covering in the longitudinal direction. A handle is provided on the straight portion of the axle having an angular locking means for adjustment.

U.S. Patent Application Publication Number 2002/0073500, filed by Pavlou, discloses a paint roller comprising an axle on which can be mounted an applicator roll said axle having first and second end caps rotatably mounted on said axle. The improvement provided by the present invention is the provision of guide means for attachment to the second end cap, said guide means having a first closed end and a second end attached to the second end cap of said paint roller. The closed end has one or more apertures and spring biased bearing means mounted in said guide means wherein the bearing means project through said apertures to guide said paint roller along a surface.

A need is still felt for device that adapted to applying paint to inner corners and edges while still being capable of applying paint to large surface areas.

### SUMMARY OF THE INVENTION

Disclosed herein are various example embodiments of the present general inventive concept. In broad terms, according to some example embodiments of the present general inventive concept, an apex roller is an application roller for applying liquid or semi-liquid substances on surfaces. A first end of the roller tapers outward to an enclosed conical point. A second end of the roller, being open, allows a paint roller shaft to enter the roller. Generally, the paint roller shaft includes a handle thereon to allow grasping by a user, the handle having a cross-axle oriented at a right angle to the shaft The roller's tubular frame, with the open second end, enables selective removal and insertion of the paint roller shaft; the roller is held in place on the paint roller shall by force of friction. Generally, a cover wrap dimensioned to circumferentially envelop the tubular frame has a liquid-absorbent outer surface.

Thus, in some example embodiments of the present general inventive concept, a roller assembly for applying paint to surface areas and to tight areas includes a roller frame including a shaft adapted to receive a roller cover and to permit an installed roller cover to rotate about a longitudinal axis defined by a length of said shaft; a roller cover including a substantially cylindrical tubular frame body having a hollow interior volume and a first end and a second end at either end of a longitudinal axis of said cylindrical tubular frame body, the first end including a continuation of the of the tubular frame body tapering to an apex, the second end open and adapted to permit access to the interior volume of said tubular frame body by the shaft of the roller frame; and a cover wrap dimensioned to circumferentially envelop said tubular frame body, said cover wrap including a liquid-absorbent outer surface adapted for temporarily retaining paint, stain, or other liquid or semi-liquid substances.

In application, the roller assembly operates much like a conventional roller in applying paint to a surface area. The substantially cylindrical tubular frame of the roller cover has sufficient length and sufficient outboard surface area to be useful in applying paint to a large surface area. The apex of the roller cover is used to apply paint to inner corners, edges, and other tight areas. Thus, through use of a roller assembly according to the present general inventive concept, a single painting tool is used to apply paint both to large surface areas and to inner corners, edges, and other tight areas.

In some embodiments, the shaft of the roller frame further comprises a conical end piece adapted to fit within a hollow interior volume defined by the apex of the first end of the tubular frame body of the roller cover.

In some example embodiments of the present general inventive concept, a roller cover assembly for use in applying paint to surface areas and to tight areas includes a roller frame including a shaft adapted to receive a roller cover and to permit an installed roller cover to rotate about a longitudinal axis defined by a length of said shaft; a roller cover including a substantially cylindrical tubular frame body having a hollow interior volume and a first end and a second end at either end of a longitudinal axis of said cylindrical tubular frame body, said substantially cylindrical tubular frame body being adapted to be fit onto a shaft of a roller frame, the first end including a continuation of the of the tubular frame body tapering to an apex, the second end open and adapted to permit access to the interior volume of said tubular frame body by the shaft of the roller frame.

In some embodiments, the roller cover assembly further includes a cover wrap dimensioned to circumferentially envelop said tubular frame body, said cover wrap including a liquid-absorbent outer surface adapted for temporarily retaining paint, stain, or other liquid or semi-liquid substances.

In some embodiments, the liquid-absorbent outer surface is adapted for temporarily retaining water-based paint.

In some embodiments, the liquid-absorbent outer surface is adapted for temporarily retaining oil-based paint.

In some embodiments, the liquid-absorbent outer surface is adapted for temporarily retaining stain.

In some embodiments, a roller cover for applying paint to surface areas and to tight areas includes a substantially cylindrical tubular frame body having a hollow interior volume and a first end and a second end at either end of a longitudinal axis of said cylindrical tubular frame body, the first end including a continuation of the of the tubular frame body tapering to an apex, the second end open and adapted to permit access to the interior volume of said tubular frame body by the shaft, of the roller frame; and a cover wrap dimensioned to circumferentially envelop said tubular frame body, said cover wrap including a liquid-absorbent outer surface adapted for temporarily retaining paint, stain, or other liquid or semi-liquid substances.

In some embodiments, the liquid-absorbent outer surface is adapted for temporarily retaining water-based paint.

In some embodiments, the liquid-absorbent outer surface is adapted for temporarily retaining oil-based paint.

In some embodiments, the liquid-absorbent outer surface is adapted for temporarily retaining stain.

### FIGURES

The above-mentioned and additional features of the invention will become more clearly understood from the following detailed description of the invention read together with the drawings in which:

FIG. 1 is a perspective view of a roller frame according to one example embodiment of the present general inventive concept;

FIG. 2 is a second perspective view of the same embodiment shown in FIG. 1, showing the tubular frame roller cover installed on the roller frame; and

FIG. 3 is a perspective view showing one example embodiment of the present general inventive concept in use.

### DETAILED DESCRIPTION

Generally, the present general inventive concept embraces a roller for applying paint (or other liquid or semi-liquid substances) to surfaces, with the roller including a tubular frame that extends in a cylindrical shape. This tubular frame has two ends. A first end tapers outward (away from the main body of the tubular frame) to an enclosed conical point. A second end is open and adapted to permit access to the interior volume of the tubular frame by a shall of a roller frame; the roller frame, in addition to the shaft, includes a handle for grasping by a user; generally, the cross axle of the shaft is oriented at substantially a right angle to the longitudinal axis of the handle. The open second end of the tubular frame permits selective removal and insertion of the paint roller shaft into the tubular frame. Typically, the tubular frame is held in place on the shaft by friction. A cover wrap dimensioned to circumferentially envelop the tubular frame is also included in the assembly; this cover wrap has a liquid-absorbent outer surface adapted for temporarily retaining paint, stain, or other liquid or semi-liquid substances.

Reference will now be made to the example embodiments of the present general inventive concept, examples of which are illustrated in the accompanying drawings and illustrations. The example embodiments are described herein in order to explain the present general inventive concept by referring to the figures.

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

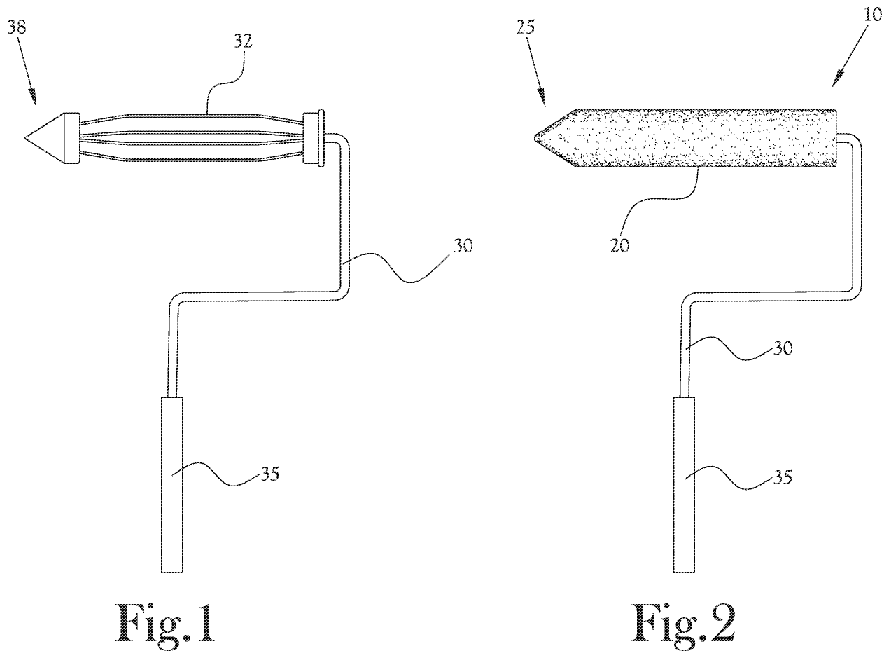

Turning to the Figures, FIGS. 1 and 2 show an assembly 10 according to one example embodiment of the present general inventive concept. The roller assembly 10 generally comprises a roller cover 20 and a roller frame 30. The roller frame 30 includes a shaft 32, adapted to receive a roller cover and to permit an installed roller cover to rotate about a longitudinal axis defined by the length of said shaft 32, the shaft 32 generally comprises a cross axle for this purpose. The roller frame 30, in addition to the shaft 32, includes a handle 35 for grasping by a user; generally, the cross axle of the shaft 32 is oriented at substantially a right angle to the longitudinal axis of the handle 35.

As shown in FIG. 2, the roller cover 20 generally comprises a substantially cylindrical tubular frame body, which includes a hollow interior volume and two ends at either end of a longitudinal axis of the cylindrical tubular frame body. At a first end of the substantially cylindrical tubular frame body, the roller cover body tapers to a conical end or apex 25. A second end is open and adapted to permit access to the interior volume of the tubular frame by the shaft 32 of the roller frame 30. The open second end of the tubular frame permits selective removal and insertion of the paint roller shaft 32 into the tubular frame of the roller cover 20. Generally, the tubular frame is held in place on the shaft 32 by friction.

A cover wrap dimensioned to circumferentially envelop the tubular frame is also included in the assembly; this cover wrap has a liquid-absorbent outer surface adapted for temporarily retaining paint, stain, or other liquid or semi-liquid substances. In some embodiments, the liquid-absorbent outer surface is specially or particularly adapted for temporarily retaining water-based paint. In some embodiments, the liquid-absorbent outer surface is specially or particularly adapted for temporarily retaining oil-based paint. In some embodiments, the liquid-absorbent outer surface is specially or particularly adapted for temporarily retaining stain. (For convenience, the term “paint” shall hereinafter be understood to encompass paint, stain, and other liquid and semi-liquid substances that are capable of being applied to a surface area by roller.)

In some example embodiments of the present general inventive concept, the shaft 32 of the roller frame 30 includes a conical end piece 38 adapted to fit within a hollow interior volume defined by the conical end or apex 25 of the roller cover 20. This conical end piece 38 helps to maintain the shape and structural integrity of the conical end or apex 25 when the roller assembly 10 is in use.

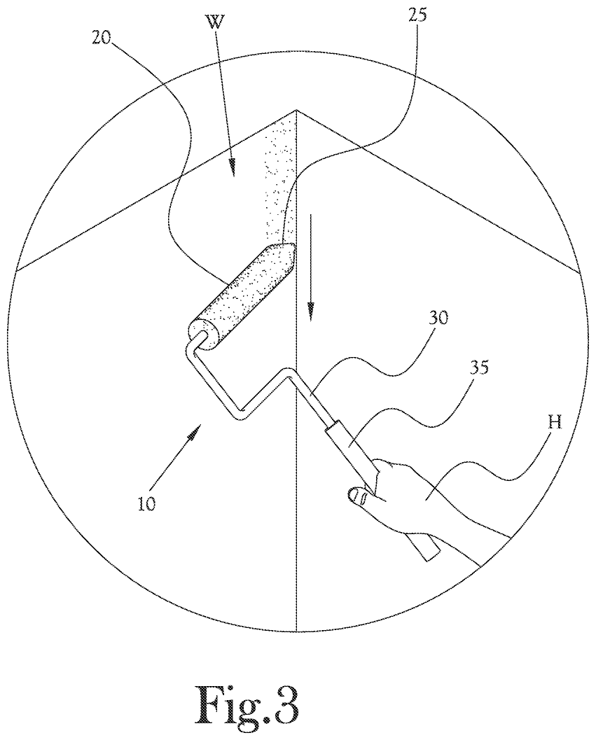

In application, the roller assembly 10 operates much like a conventional roller in applying paint to a surface area. The substantially cylindrical tubular frame of the roller cover 20 has sufficient length and sufficient outboard surface area to be useful in applying paint to a large surface area. As shown in FIG. 3, the conical end or apex 25 of the roller cover is used to apply paint to inner corners, edges, and other tight areas of a wall or painting surface W. The handle 35 allows a user H to grasp and manipulate the roller assembly 10. Thus, through use of a roller assembly according to the present general inventive concept, a single painting tool is used to apply paint both to large surface areas and to inner corners, edges, and other tight areas.

Various example embodiments of the present general inventive concept provide apparatus and means suitable for applying paint to inner corners while also being useful for painting large surface areas away from edges and corners. Embodiments of the present general inventive concept reduce or eliminate the need to use a brush or other small tool for applying paint in tight areas, reducing the number of painting tools that must be purchased, cleaned, and maintained. Embodiments of the present general inventive concept help produce a painted surface without different textures in places where different painting implements have been utilized. Moreover, embodiments of the present general inventive concept make the process of applying paint in tight areas more efficient and less time-consuming.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A roller assembly for applying paint to surface areas and to tight areas, comprising:
a roller frame including a shaft adapted to receive a roller cover and to permit an installed roller cover to rotate about a longitudinal axis defined by a length of said shaft;
a roller cover including a substantially cylindrical tubular frame body having a hollow interior volume and a first end and a second end at either end of a longitudinal axis of said cylindrical tubular frame body,
the first end including a continuation of the of the tubular frame body tapering to an apex,
the second end open and adapted to permit access to the interior volume of said tubular frame body by the shaft of the roller frame; and
a cover wrap dimensioned to circumferentially envelop said tubular frame body, said cover wrap including a liquid-absorbent outer surface adapted for temporarily retaining paint, stain, or other liquid or semi-liquid substances.

2. The assembly of claim 1, wherein the shaft of the roller frame further comprises a conical end piece adapted to fit within a hollow interior volume defined by the apex of the first end of the tubular frame body of the roller cover.

3. A roller cover assembly for use in applying paint to surface areas and to tight areas, comprising:
a roller frame including a shaft adapted to receive a roller cover and to permit an installed roller cover to rotate about a longitudinal axis defined by a length of said shaft;
a roller cover including a substantially cylindrical tubular frame body having a hollow interior volume and a first end and a second end at either end of a longitudinal axis of said cylindrical tubular frame body, said substantially cylindrical tubular frame body being adapted to be fit onto a shaft of a roller frame,
the first end including a continuation of the of the tubular frame body tapering to an apex,
the second end open and adapted to permit access to the interior volume of said tubular frame body by the shaft of the roller frame.

4. The roller cover assembly of claim 3 further comprising a cover wrap dimensioned to circumferentially envelop said tubular frame body, said cover wrap including a liquid-absorbent outer surface adapted for temporarily retaining paint, stain, or other liquid or semi-liquid substances.

5. The roller cover assembly of claim 4, wherein said liquid-absorbent outer surface is adapted for temporarily retaining water-based paint.

6. The roller cover assembly of claim 4, wherein said liquid-absorbent outer surface is adapted for temporarily retaining oil-based paint.

7. The roller cover assembly of claim 4, wherein said liquid-absorbent outer surface is adapted for temporarily retaining stain.

8. A roller cover for applying paint to surface areas and to tight areas, comprising:
a substantially cylindrical tubular frame body having a hollow interior volume and a first end and a second end at either end of a longitudinal axis of said cylindrical tubular frame body,
the first end including a continuation of the of the tubular frame body tapering to an apex,
the second end open and adapted to permit access to the interior volume of said tubular frame body by the shaft of the roller frame; and
a cover wrap dimensioned to circumferentially envelop said tubular frame body, said cover wrap including a liquid-absorbent outer surface adapted for temporarily retaining paint, stain, or other liquid or semi-liquid substances.

9. The roller cover of claim 8, wherein said liquid-absorbent outer surface is adapted for temporarily retaining water-based paint.

10. The roller cover of claim 8, wherein said liquid-absorbent outer surface is adapted for temporarily retaining oil-based paint.

11. The roller cover of claim 8, wherein said liquid-absorbent outer surface is adapted for temporarily retaining stain.
